(19) United States
(12) Patent Application Publication
(10) Pub. No.: US 2013/0300684 A1
(43) Pub. Date: Nov. 14, 2013

(54) APPARATUS AND METHOD FOR EXECUTING MULTI APPLICATIONS

(71) Applicant: SAMSUNG ELECTRONICS CO. LTD., Suwon-si (KR)

(72) Inventors: Eun-Young KIM, Yongin-si (KR); Kang-Tae KIM, Yongin-si (KR); Chul-Joo KIM, Suwon-si (KR); Kwang-Won SUN, Suwon-si (KR); Jae-Yul LEE, Goyang-si (KR)

(73) Assignee: SAMSUNG ELECTRONICS CO. LTD., Suwon-si (KR)

(21) Appl. No.: 13/778,955

(22) Filed: Feb. 27, 2013

Related U.S. Application Data
(60) Provisional application No. 61/645,928, filed on May 11, 2012.

(30) Foreign Application Priority Data
Jul. 4, 2012 (KR) 10-2012-0073102

(51) Int. Cl. G06F 3/0488

(52) U.S. Cl. CPC G06F 3/0488
USPC 345/173

(57) ABSTRACT

A method of executing multiple applications in an apparatus including a touch screen is provided. The method includes displaying a first window in which a first application is executed on the touch screen, detecting a division screen display event of the first application and a second application, and decreasing a size of the first window on the touch screen when the division screen display event is detected and displaying, together with the first window, a second window in which the second application is executed on the touch screen.

### CROSS-REFERENCE TO RELATED APPLICATIONS

This application claims the benefit under 35 U.S.C. §119(e) of a U.S. provisional patent application filed on May 11, 2012 in the U.S. Patent and Trademark Office and assigned Ser. No. 61/645,928, and under 35 U.S.C. §119(a) of a Korean patent application filed on Jul. 4, 2012 in the Korean Intellectual Property Office and assigned Serial No. 10-2012-0073102, the entire disclosure of each of which is hereby incorporated by reference.

### BACKGROUND OF THE INVENTION

1. Field of the Invention

The present invention relates to an apparatus and a method for executing multiple applications. More particularly, the present invention relates to an apparatus and a method for efficiently executing multiple applications by using a user interface which is implemented in a touch screen.

2. Description of the Related Art

A desktop computer includes at least one display apparatus (e.g., a monitor). A mobile apparatus (e.g., a portable phone, a smart phone, a tablet PC, or the like) using a touch screen includes a display apparatus.

A user of a desktop computer may divide and use a screen of the display apparatus (e.g., open a plurality of windows and divide the screen in a horizontal direction or a vertical direction with the plurality of windows) according to the work environment. When a web browser is executed, a web page may be moved in an upward direction or a downward direction by using a page up button or a page down button on a key board. When a mouse is used instead of the key board, the web page may be moved in the upward direction or the downward direction by selecting a scroll bar on a side of the web page with a mouse cursor. In addition, the web page may be moved to a top most portion thereof by selecting a top button displayed in a text or an icon at a lower portion of the web page.

The mobile apparatus has a display screen which is smaller than that of the desktop computer and has limited input.

The mobile apparatus is manufactured by a manufacturer of the apparatus such that various applications, such as default applications installed on the apparatus and additional applications downloaded through an application sales site on the Internet, may be executed. The additional applications may be developed by general users and registered on the sales site.

Thus, various applications which trigger a customer's curiosity and satisfy the customer's desire are provided to the mobile apparatus. However, since the mobile apparatus is manufactured in a portable size, the mobile apparatus is limited in a size of a display thereof and a User Interface (UI). Accordingly, user inconvenience exists in executing a plurality of applications on the mobile apparatus. For example, in the mobile apparatus, when one application is executed, the application is displayed on an entire display area of the display. In addition, when another wanted application is to be executed, a currently executed application needs to be first terminated and an execution key for executing the wanted application needs to be selected. In other words, in order to execute various applications in the mobile apparatus, processes for executing and terminating each application need to be repeated, thereby causing inconvenience.

Therefore, a need exists for an apparatus and a method for efficiently executing multiple applications by using a user interface which is implemented in a touch screen.

The above information is presented as background information only to assist with an understanding of the present disclosure. No determination has been made, and no assertion is made, as to whether any of the above might be applicable as prior art with regard to the present invention.

### SUMMARY OF THE INVENTION

Aspects of the present invention are to address at least the above-mentioned problems and/or disadvantages and to provide at least the advantages described below. Accordingly, an aspect of the present invention is to provide an apparatus and a method for dividing and displaying a plurality of applications on a touch screen.

In accordance with an aspect of the present invention, a method of executing multiple applications in an apparatus including a touch screen is provided. The method includes displaying a first window in which a first application is executed on the touch screen, detecting a division screen display event of the first application and a second application, and decreasing a size of the first window on the touch screen when the division screen display event is detected and displaying, together with the first window, a second window in which the second application is executed on the touch screen.

In accordance with another aspect of the present invention, an apparatus for executing a plurality of applications is provided. The apparatus includes a touch screen for displaying a first window in which a first application is executed and a controller for detecting a division screen display event of the first application and a second application and for decreasing a size of the first window on the touch screen when the division screen display event is detected and displaying, together with the first window, a second window in which the second application is executed on the touch screen.

According to another aspect of the present invention, a plurality of applications may be divided and displayed by a convenient user interface. In addition, while the user executes one application, another application may be executed, thereby creating a remarkable effect of identifying two applications at the same time.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1A is a block diagram illustrating a mobile apparatus according to an exemplary embodiment of the present invention;

FIG. 1B illustrates a mobile apparatus according to an exemplary embodiment of the present invention;

FIGS. 2A and 2B illustrate an operation of comparison examples of application executing screens according to an exemplary embodiment of the present invention;

FIG. 2C illustrates a frame which supports a comparison example according to an exemplary embodiment of the present invention;

FIG. 3A illustrates an application executing and displaying apparatus according to an exemplary embodiment of the present invention;

FIG. 3B illustrates an application executing and displaying apparatus according to an exemplary embodiment of the present invention;

FIG. 3C illustrates a display of an application list according to an exemplary embodiment of the present invention;

FIG. 3D illustrates a display of screen division in an apparatus according to an exemplary embodiment of the present invention;

FIG. 3E illustrates a display of screen division based on execution of an application according to an exemplary embodiment of the present invention;

FIG. 3F illustrates a display of screen division in an apparatus according to an exemplary embodiment of the present invention;

FIG. 3G illustrates a display of a divided screen in an apparatus according to an exemplary embodiment of the present invention;

FIG. 4 illustrates a framework according to an exemplary embodiment of the present invention;

FIG. 5 is a flowchart illustrating a method of executing multiple applications according to an exemplary embodiment of the present invention;

FIG. 6 is a flowchart illustrating a method of executing multiple applications according to an exemplary embodiment of the present invention;

FIGS. 7A and 7B illustrate a display of screen division in an apparatus according to an exemplary embodiment of the present invention; and

FIGS. 8A through 8D illustrate an application list according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

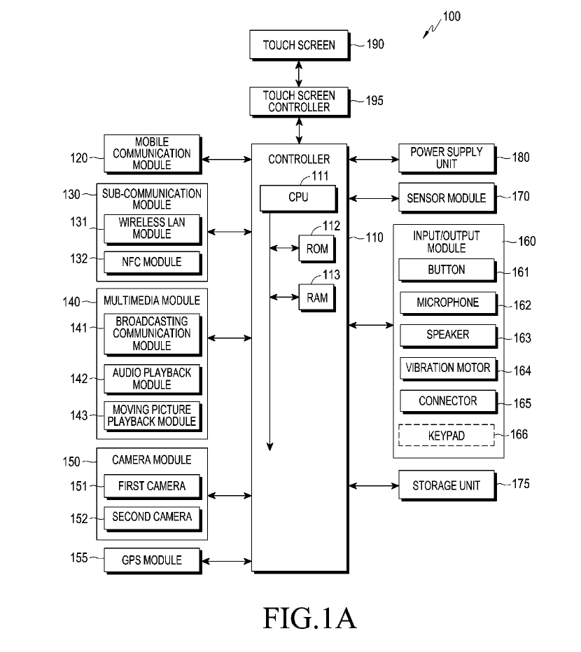

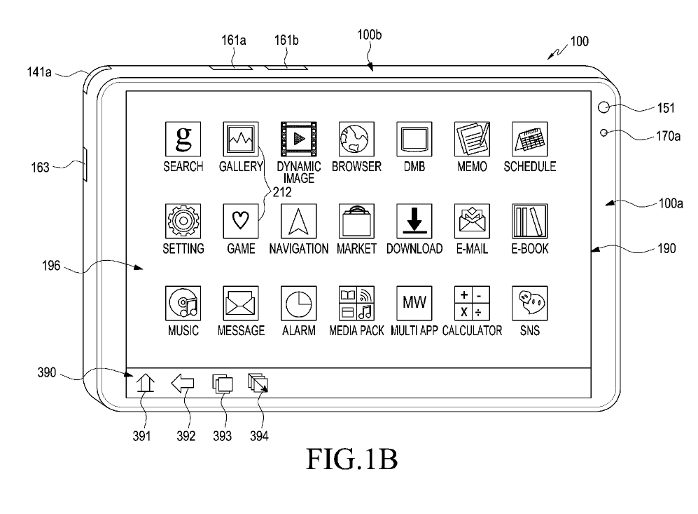

FIG. 1A is a block diagram illustrating a mobile apparatus according to an exemplary embodiment of the present invention.

Referring to FIG. 1A, an apparatus 100 may be connected to an external device (not shown) by using a mobile communication module 120, a sub communication module 130, and a connector 165. The external device includes another device (not shown), a portable terminal (not shown), a smart phone (not shown), a tablet Personal Computer (PC) (not shown), and a server (not shown).

Referring to FIG. 1A, the apparatus 100 includes a touch screen 190 and a touch screen controller 195. In addition, the apparatus 100 includes a controller 110, the mobile communication module 120, the sub communication module 130, a multimedia module 140, a camera module 150, a Global Positioning System (GPS) module 155, an input/output module 160, a sensor module 170, a storage unit 175, and a power supply unit 180. The sub communication module 130 includes at least one of a wireless Local Area Network (LAN) module 131 and a short range communication (i.e., a Near Field Communication (NFC)) module 132, and the multimedia module 140 includes at least one of a broadcast communication module 141, an audio reproducing module 142, and a video reproducing module 143. The camera module 150 includes at least one of a first camera 151 and a second camera 152, and the input/output module 160 includes at least one or all of a button 161, a microphone 162, a speaker 163, a vibration motor 164, the connector 165, and a keypad 166.

The controller 110 may include a Central Processing Unit (CPU) 111, a Read Only Memory (ROM) 112 for storing a control program for controlling the apparatus 100, and a Random Access Memory (RAM) 113 for recollecting a signal or a data input or used as a memory area for a task performed by the apparatus 100. The CPU may include a single core, a dual core, a triple core, or a quad core. The CPU 111, the ROM 112, and the RAM 113 may be inter connected to one another through an internal bus.

The controller 110 may control the mobile communication module 120, the sub communication module 130, the multimedia module 140, the camera module 150, the GPS module 155, the input/output module 160, the sensor module 170, the storage unit 175, the power supply unit 180, a first touch screen 190a, a second touch screen 190b, and the touch screen controller 195.

The mobile communication module 120 connects the apparatus 100 to the external apparatus through a mobile communication by using one or a plurality of antennas (not shown) according to a control of the controller 110. The mobile communication module 120 transmits and receives a wireless signal for a voice call, a video call, a text message (i.e., a Short Message Service (SMS)), or a Multimedia Message Service (MMS) with a portable phone (not shown), a smart phone (not shown), a tablet PC (not shown), or another device (not shown) having a phone number input on the apparatus 100.

The sub communication module 130 includes at least one of the wireless LAN module 131 and the short range communication module 132. For example, the sub communication module 130 may include only the wireless LAN module 131, or only the short range communication module 132, or both the wireless LAN module 131 and the short range communication module 132.

The wireless LAN module 131 may be connected to the Internet at a location where a wireless Access Point (AP) is installed according to the control of the controller 110. The wireless LAN module 131 supports a wireless LAN standard IEEE802.11x of the Institute of Electrical and Electronics Engineers (IEEE). The short range communication module 132 may perform a wireless short range communication between the apparatus 100 and a video formation apparatus (not shown) according to the control of the controller 110. A short range communication method may include, for example, Bluetooth, an Infrared Data Association (IrDA) communication, and the like.

The apparatus 100, depending on performance thereof, may include at least one of the mobile communication module 120, the wireless LAN module 131, and the short range communication module 132. For example, the apparatus 100, depending on performance thereof, may include a combination of the mobile communication module 120, the wireless LAN module 131, and the short range communication module 132.

The multimedia module 140 may include the broadcast communication module 141, the audio reproducing module 142, or the video reproducing module 143. The broadcast communication module 141 may receive a broadcast signal (e.g., a Television (TV) broadcast signal, a radio broadcast signal, or a data broadcast signal) or additional broadcast information (e.g., an Electric Program Guide (EPS) or an Electric Service Guide (ESG)) transmitted from a base station through a broadcast communication antenna (not shown) according to the control of the controller 110. The audio reproducing module 142 may reproduce a digital audio file (e.g., a file having a file extension of mp3, wma, ogg, or way) which is stored or received according to the control of the controller 110. The video reproducing module 143 may reproduce a digital video file (e.g., a file having a file extension of mpeg, mpg, mp4, avi, mov, or mkv) which is stored or received according to the control of the controller 110. The video reproducing module 143 may reproduce the digital audio file.

The multimedia module 140 may include the audio reproducing module 142 and the video reproducing module 143, except for the broadcast communication module 141. In addition, the audio reproducing module 142 or the video reproducing module 143 of the multimedia module 140 may be included in the controller 110.

The camera module 150 may include at least one of the first camera 151 and the second camera 152 which photographs a still image or a video according to the control of the controller 110. The first camera 151 or the second camera 152 may include an auxiliary light source (e.g., a flash (not shown)) which provides a quantity of light needed for photographing. The first camera 151 may be disposed on a front surface of the apparatus 100 and the second camera 152 may be disposed on a rear surface of the apparatus 100. Alternatively, the first camera 151 and the second camera 152 may be disposed in proximity (e.g., an interval between the first camera 151 and the second camera 152 is greater than 1 cm and less than 8 cm) to photograph a three dimension still image or a three dimension video.

The GPS module 155 may receive a radio wave from a plurality of GPS satellites (not shown) which is on an orbit of the earth and may calculate a location of the apparatus 100 by using a time of arrival of the radio wave from the GPS satellite (not shown) to the apparatus 100.

The input/output module 160 may include at least one of a plurality of the buttons 161, the microphone 162, the speaker 163, the vibration motor 164, the connector 165, and the keypad 166.

The button 161 may be formed on a front surface, a side surface, or a rear surface of a housing of the apparatus 100 and may include at least one of a power/lock button (not shown), a volume button (not shown), a menu button, a home button, a back button, and a search button 161.

The microphone 162 receives a voice or a sound according to the control of the controller 110 to generate an electric signal.

The speaker 163 may output, toward an outside of the apparatus 100, a sound corresponding to various signals (e.g., a wireless signal, a broadcast signal, a digital audio file, a digital video file, or photographing) of the mobile communication module 120, the sub communication module 130, the multimedia module 140, or the camera module 150 according to the control of the controller 110.

The speaker 163 may output a sound (e.g., a button manipulation sound corresponding to a call dialing or a call connection sound) corresponding to a function performed by the apparatus 100. One or a plurality of speakers 163 may be formed on an appropriate location or locations of the housing of the apparatus 100.

The vibration motor 164 may convert the electrical signal to a mechanical vibration according to the control of the controller 110. For example, when the apparatus 100 which is in a vibration mode receives a voice call from another device (not shown), the vibration motor 164 is operated. One or a plurality of vibration motors 164 may be formed within the housing of the apparatus 100. The vibration motor 164 may operate in response to a user's touch gesture that touches the touch screen 190 and a continuous movement of a touch on the touch screen 190.

The connector 165 may be used as an interface for connecting the apparatus 100 to an external apparatus (not shown) or a power source (not shown). A data stored in the storage unit 175 of the apparatus 100 may be transmitted to the external apparatus (not shown) or a data from the external apparatus (not shown) may be received through a wire cable connected to the connector 165 according to the control of the controller 110. Power may be received or a battery (not shown) may be charged from a power source (not shown) through the wire cable connected to the connector 165.

The keypad 166 may receive a key input from a user to control the apparatus 100. The keypad 166 may include a physical keypad (not shown) formed on the apparatus 100 or a virtual keypad (not shown) displayed on the touch screen 190. The physical keypad (not shown) formed on the apparatus 100 may be excluded according to performance or structure of the apparatus 100.

The sensor module 170 includes at least one sensor for detecting a state of the apparatus 100. For example, the sensor module 170 may include a proximity sensor for detecting proximity of the apparatus 100 to the user, an illumination sensor (not shown) for detecting a quantity of light near the apparatus 100, or a motion sensor (not shown) for detecting an operation (e.g., rotation of the apparatus 100, acceleration or vibration applied to the apparatus 100) of the apparatus 100. The at least one sensor may detect a state and transmit a signal corresponding to detection to the controller 110. The sensor of the sensor module 170 may be added or deleted depending on performance of the apparatus 100.

The storage unit 175, according to a control of the controller 110, may store a signal or a data input or output corresponding to an operation of the mobile communication module 120, the sub communication module 130, the multimedia module 140, the camera module 150, the GPS module 155, the input/output module 160, the sensor module 170, and the touch screen 190. The storage unit 175 may store the control program or applications for controlling the apparatus 100 or the controller 110.

The term “storage unit” includes a memory card (not shown) (e.g., a Secure Digital (SD) card, a memory stick, and the like) which is mounted on the storage unit 175, the ROM 112 or the RAM 113 within the controller 110, or the apparatus 100. The storage unit may include a non-volatile memory, a volatile memory, a Hard Disk Drive (HDD), or a Solid State Drive (SSD). The power supply unit 180 may supply power to one or a plurality of batteries (not shown) which is disposed on the housing of the apparatus 100 according to the control of the controller 110. The one or the plurality of batteries (not shown) provides power to the apparatus 100. In addition, the power supply unit 180 may provide power, input from an external power source (not shown) through the wire cable connected to the connector 165, to the apparatus 100.

The touch screen 190 may provide the user with a user interface corresponding to various services (e.g., a call, a data transmission, a broadcast, a photographing function, and the like). The touch screen 190 may transmit an analog signal corresponding to at least one touch, input to the user interface, to the touch screen controller 195. The touch screen 190 may receive at least one touch through a body of the user (e.g., a finger including a thumb) or an input means (e.g., a stylus pen) capable of performing a touch. In addition, the touch screen 190 may receive continuous movement of a touch among the at least one touch. The touch screen 190 may transmit an analog signal corresponding to continuous movement of an input touch to the touch screen controller 195.

In exemplary embodiments of the present invention, a touch may not be limited to a touch on the touch screen 190 by the user's body or a touch by the input means (e.g., a stylus pen) capable of performing a touch and may include a non-contact (e.g., a detectable interval between the touch screen 190 and the user's body or the input means capable of performing a touch is equal to or less than 1 mm) An interval detectable from the touch screen 190 may be varied depending on the performance or structure of the apparatus 100.

The touch screen 190, for example, may be implemented in a resistive type, a capacitive type, an infrared type, or an acoustic wave type. The touch screen controller 195 converts an analog signal received from the touch screen 190 into a digital signal (e.g., X and Y coordinates) to be transmitted to the controller 110. The controller 110 may control the touch screen 190 by using a digital signal received from the touch screen controller 195. For example, the controller 110 may select a shortcut icon (not shown) displayed on the touch screen 190 or execute the shortcut icon (not shown) in response to a touch. In addition, the touch screen controller 195 may be included in the controller 110.

FIG. 1B illustrates a mobile apparatus according to an exemplary embodiment of the present invention.

Referring to FIG. 1B, the touch screen 190 is disposed on a center of a front surface 100a of the apparatus 100. The touch screen 190 is formed to be large so as to occupy most of the front surface 100a of the apparatus 100. On an edge of the front surface 100a of the apparatus, the first camera 151 and an illumination sensor 170a may be disposed. On a side surface 100b of the apparatus 100, for example, a power/reset button 161a, a volume button 161b, the speaker 163, a terrestrial Digital Multimedia Broadcasting (DMB) antenna 141a for receiving a broadcast, a microphone (not shown), and a connector (not shown) may be disposed, and on a rear side (not shown) of the apparatus 100, the second camera (not shown) may be disposed.

The touch screen 190 may include a main screen 196 and a lower portion bar 390. In FIG. 1B, the apparatus 100 and the touch screen 190 are respectively arranged such that a horizontal direction length thereof is longer than a vertical direction length thereof. In this case, the touch screen 190 is defined to be arranged in a horizontal direction.

The main screen 196 is an area in which one or a plurality of applications is executed. In FIG. 1B, an example in which a home screen is displayed on the touch screen 190 is shown. The home screen is a first screen which is displayed on the touch screen 190 when the apparatus 100 is powered on. In the home screen, execution keys 212 for executing a plurality of applications stored in the apparatus 100 are arranged and displayed in rows and columns. The execution keys 212 may be formed in icons, buttons, or a text. When each execution key 212 is touched, an application corresponding to a touched execution key 212 is executed to be displayed on the main screen 196.

The lower portion bar 390 is elongated in the horizontal direction at a lower portion of the touch screen 190 and includes standard function buttons 391 through 394. A home screen movement button 391 displays the home screen on the main screen 196. For example, when the home screen movement key 391 is touched while applications are executed on the main screen 196, a home screen shown in FIG. 1B is displayed. A back button 392 displays a screen which is executed immediately previous to a currently executed screen or terminates an application which is most recently used. A multi view mode button 393 displays applications in a multi view mode on the main screen 196. A mode switch button 394 switches a plurality of applications currently executed to different modes to be displayed on the main screen 196. For example, when the mode switch button 394 is touched, in the apparatus 100, an overlap mode in which a plurality of applications is partially overlapped with each other and a split mode in which the plurality of applications is each separately displayed in a different area on the main display screen 196 may be switched to each other.

In an upper portion of the touch screen 190, an upper portion bar (not shown) for displaying a state of the apparatus 100, such as a battery charging state, an intensity of a received signal, and the current time may be formed.

On the other hand, according to an Operating System (OS) of the apparatus 100 or an application executed in the apparatus 100, the lower portion bar 390 and the upper portion bar (not shown) may not be displayed on the touch screen 390. If all of the lower portion bar 390 and the upper portion bar (not shown) are not displayed on the touch screen 390, the main screen 196 may be displayed on an entire area of the touch screen 190. The lower portion bar 390 and the upper portion bar (not shown) may be transparently displayed in overlap on the main screen 196.

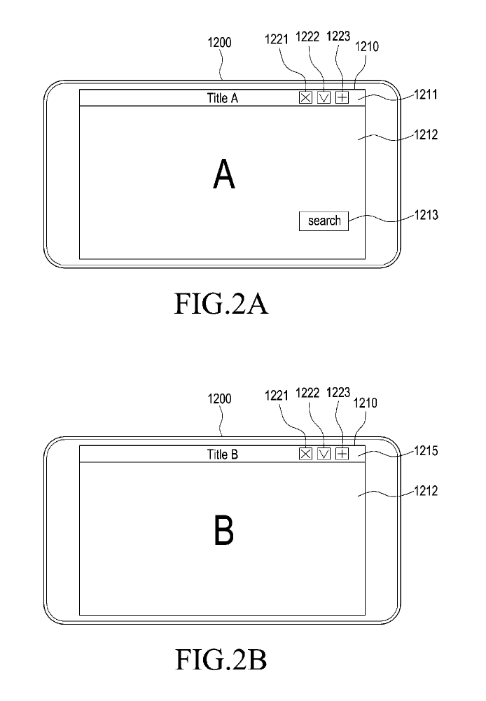

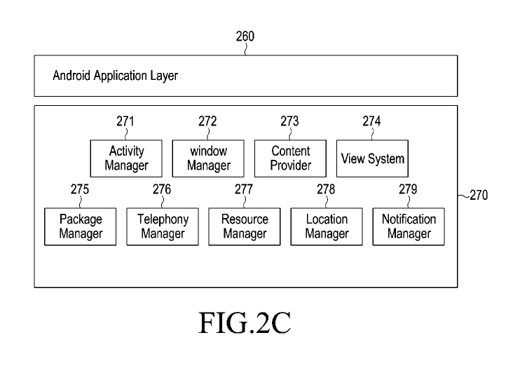

FIGS. 2A and 2B illustrate an operation of comparison examples of application executing screens according to an exemplary embodiment of the present invention.

Referring to FIGS. 2A and 2B, an apparatus 1200 according to a comparison example may include a touch screen 1210. In a comparison example of FIG. 2A, it is assumed that the apparatus 1200 executes a first application A. A title bar 1211 is displayed at an upper portion of the touch screen 1210 and an execution screen 1212 of the first application A is displayed at a lower portion of the title bar 1211.

Here, the title bar 1211 may be displayed with an identifier for identifying the first application A and a function key 1221 capable of terminating a display of the first application A, a function key 1222 capable of minimizing the display of the first application A, and a function key 1223 capable of recovering to an initial menu screen.

On the other hand, the first application A may include an execution key 1213 for performing to switch to a second application B. When the user executes the execution key 1213 for performing a switch from the first application A, the apparatus 1200 according to the comparison example switches a screen. More specifically, the apparatus 1200 may switch an entire screen based on a request from the first application A. For example, when the execution key 1213 is to execute the second application B to be displayed on an entire screen, the apparatus 1200 displays a title bar 1215 of the second application B and a display screen of the second application B on an entire area of the touch screen 1210.

Applications are a program independently implemented by a manufacturer of the apparatus 1200 or an application developer. Accordingly, in order to execute one application, it is not required to execute other applications in advance. In addition, even if one application is terminated, other applications may be continuously executed.

FIG. 2C illustrates a frame which supports a comparison example according to an exemplary embodiment of the present invention.

Referring to FIG. 2C, the frame which supports the comparison example may include an application layer 260 and a framework 270.

The application layer 260 may be a group of applications which operate by using an Application Program Interface (API) provided by the framework 270 and may include a third party application.

The framework 270 provides the API such that developers may implement an application based on the provided API.

An activity manager 271 serves to activate an application such that a plurality of applications is simultaneously performed.

The window manager 272 draws or controls a plurality of windows, for example, touches, moves, or resizes the plurality of windows.

A content provider 273 may enable an application to access data from another application or share a data thereof.

A view system 274 serves to process a layout, a border, and a button of a single window and redraws an entire screen.

A package manager 275 serves to process and manage an application.

A telephony manager 276 serves to process and manage telephone communication.

A resource manager 277 provides an access to a non-code resource, such as a localized character row, a graphic, a layout file, and the like.

A location manager 278 serves to process and manage location information using a GPS.

A notification manager 279 serves to process and manage an event generated in a system, for example, an alarm, a battery, and a network connection.

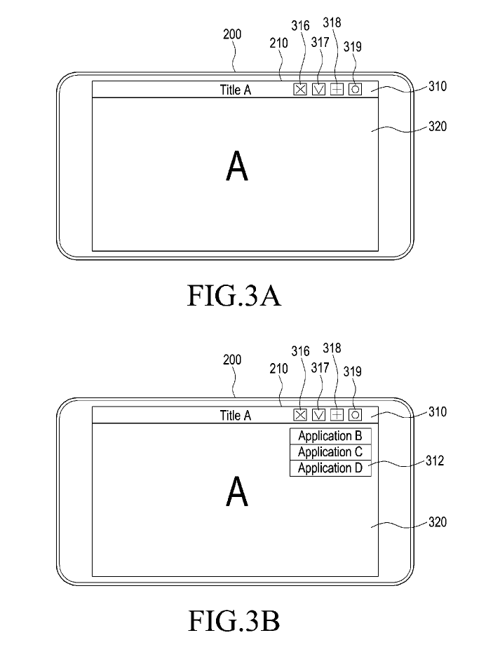

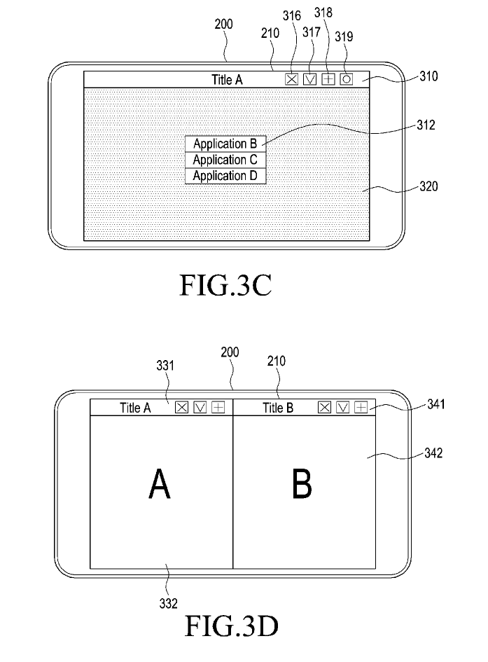

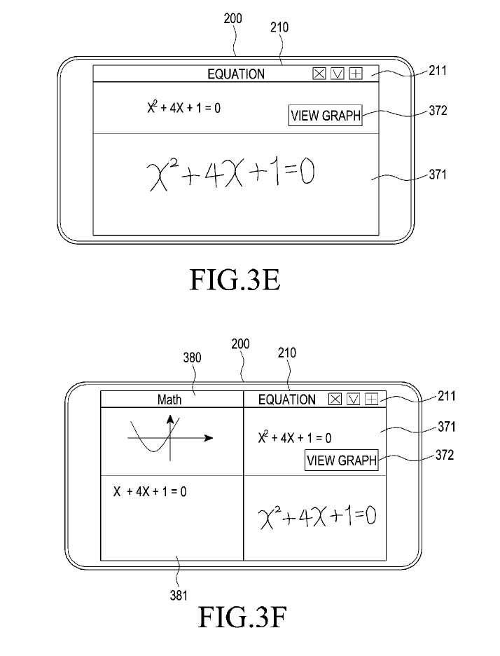

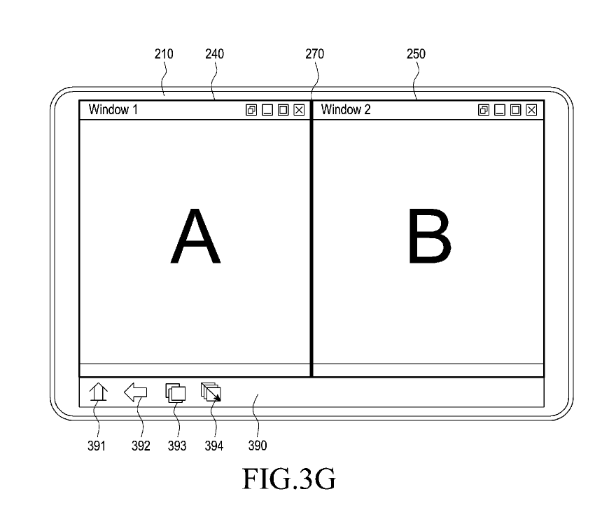

FIG. 3A illustrates an application executing and displaying apparatus according to an exemplary embodiment of the present invention.

Referring to FIG. 3A, the apparatus 200 may include a touch screen 210. In the exemplary embodiment of FIG. 3A, it is assumed that the apparatus 200 executes and displays the first application A.

A controller 110 displays a title bar 310 of the first application A and an execution screen 320 of the first application A on the touch screen 210. For example, the title bar 310 may be displayed at an upper portion of the touch screen 210 and the execution screen 320 of the first application A may be displayed below the title bar 310. Here, an area in which the title bar and the application are executed may be referred to as a window. The title bar of the first application A and the execution screen of the first application A may be collectively referred to as a first window. In an execution screen of the application, objects related to the application may be displayed. The objects may be formed in various shapes, such as a text, a figure, an icon, a button, a check box, a picture, a video, a web, a map, and the like. When the user touches the object, a function or an event preset for the object may be performed in a corresponding application. The object may be called as a view depending on the operating system. Here, the title bar 310 may be supported at a framework level and the execution screen of the application may be supported at an application layer.

On the title bar 310, a termination function key 316, a minimization function key 317, an initial menu division function key 318 and a screen division display function key 319 for a screen division display may be displayed. The screen division display function key 319 may be a function key for respectively dividing an entire screen of the touch screen 210 to respectively display different applications on respective areas.

FIG. 3B illustrates an application executing and displaying apparatus according to an exemplary embodiment of the present invention.

Referring to FIG. 3B, when a designated input of the screen division display function key 319 is input from the user, the controller 110 displays an executable application list 312 on a pre-designated area of the execution screen of the first application A. The controller 110 displays the application list 312 below the title bar 310, particularly below the screen division display function key 319 of the title bar 310. Accordingly, the application list 312 may be displayed on a right upper portion of the execution screen of the application, as shown in FIG. 3B. The application list 312 may be displayed in a form of covering the execution screen of the first application A and may display executable application lists. A list of the application displayed on the application list 312 will be described. On the other hand, the controller 110 of the exemplary embodiment of FIG. 3B may control to activate both the application list 312 and the execution screen 320 of the first application A. In other words, even when the application list 312 is displayed, the user may input a predefined command, for example, a touch or a drag gesture on the execution screen 320 of the first application A to execute the first application A.

FIG. 3C illustrates a display of an application list according to an exemplary embodiment of the present invention. FIG. 3D illustrates a display of screen division in an apparatus according to an exemplary embodiment of the present invention.

Referring again to FIG. 3A, when a designation of the screen division display function key 319 is input from the user, the controller 110 displays the application list 312 at a center of the execution screen 320 of the first application A. Contrary to the exemplary embodiment of FIG. 3B, the controller 110 according to the exemplary embodiment of FIG. 3C displays the application list 312 as covering the execution screen 320 of the first application A and may display a rest of the execution screen 320 of the first application A to be darker than before execution.

Referring to FIGS. 3C and 3D, the controller 110 may activate only the application list 312 and deactivate the execution screen 320 of the first application A. Accordingly, even when a command for the first application A is received from the user, the controller 110 may control not to perform an operation of the first application A corresponding to the command.

On the other hand, the application list 312 according to FIGS. 3C and 3D may be supported from the framework, not the application layer. Although the application list 312 is shown on the execution screen 320 of the first application A as shown in FIGS. 3C and 3D, it is due to a display control from the framework, not the operation of the first application A. Furthermore, it is given as an example that the application list 312 is displayed on the execution screen 320 of the first application A, and the application list 312 is not limited in position at which the application list 312 is displayed and, for example, the application list 312 may be displayed on the title bar 310. The framework may control the size of the execution screen of the first application A. More specifically, the framework may decrease the size of the execution screen of the first application A to half of the touch screen 210 as an execution screen 342 of the second application B is displayed. Moreover, the framework may form the execution screen of the second application B and control the formed execution screen of second application B to be displayed on the half of the touch screen 210. In addition, when the user terminates the second application B, the framework may control the execution screen of the second application B to disappear and increase the size of the execution screen of the first application A to a full size of the touch screen 210. In conclusion, the size of the execution screen of the application may be controlled not by an application layer but by the framework.

In the exemplary embodiment of FIG. 3B or 3C, the user may input an execution command of one application from the application list 312. For example, when a touch is received from the user on an area for a specific application among the application list 312, the controller 110 may determine the touch as an execution command for the second application.

The controller 110 displays an execution screen 332 of the first application A and an execution screen 342 of the second application B. In addition, the controller 110 displays a title bar 331 of the first application A at an upper portion of the execution screen 332 of the first application A and displays a title bar 341 of the second application B at an upper portion of the execution screen 342 of the second application B. A first window and a second window may be, for example, formed in the same size. The first window and the second window may be, for example, formed in different sizes.

The execution screen of the first application A may be displayed on an entire area of the touch screen 210 as shown in FIG. 3A and may be displayed in a reduced size on the first window which is an area on a left side relative to a center of the screen. The controller 110 may display the execution screen of the first application A at the same width-to-height ratio as a width-to-height ratio prior to display in the reduced size. Alternatively, the controller 110 may display the execution screen of the first application A at a width-to-height ratio optimized to the first window.

The execution screen 342 of the second application B may be displayed on the second window which is an area on a right side relative to the center of the screen. The controller 110 may display the execution screen of the second application B at a default width-to-height ratio of the second application B or a width-to-height ratio optimized to the second window.

On the other hand, widths of the first window and the second window are merely for illustrative purposes and those skilled in the art can easily modify a structure in which a specific window between the first window and the second window is displayed as being relatively wide. Display of a screen for the first application A in the reduced size on a left side window relative to a boundary is also for illustrative purposes and the controller 110 may display, in the reduced size, the screen for the first application A on a right side window relative to the boundary. Furthermore, the first window and the second window being adjacent to each other in a left and right direction is also for illustrative purposes and the first window and the second window may be displayed as being adjacent to each other in an upward and downward direction.

As described above, when a preset event, such as designation of the screen division display function key is detected, the controller 110 displays, in a reduced size, an application screen displayed on an entire screen on a specific window and an application screen which is newly executed on another window. Accordingly, the user may be provided with a user interface in which another application is easily divided and displayed while the user executes a specific application, thereby maximizing user convenience.

On the other hand, when the user, for example, terminates an execution of the second application B, the controller 110 may control to again display the execution screen of the first application B on an entire area of the touch screen 210 as shown in FIG. 3A.

In the above described exemplary embodiment, a screen division process based on an input of the screen division execution key 312 which is displayed on the title bar 310 supported from the framework of the apparatus 200 is described. Hereinafter, the screen division process by an application which supports a screen division function is described.

FIG. 3E illustrates a display of screen division based on execution of an application according to an exemplary embodiment of the present invention.

Referring to FIG. 3E, the controller 110 displays a title bar 211 at an upper portion of the touch screen 210 and an execution screen 361 of the first application below the title bar 211. The first application may be an application which receives an input of a predefined equation by a hand and recognizes that equation. The first application may include a function key 372 which identifies a graph of the recognized equation. On the other hand, the function key 372 may not be a graph provided by the first application but may be a function key for identifying a corresponding graph by inputting an equation recognized by the second application. For example, the first application may be a memo application which recognizes a hand written note and the second application may be an application for outputting a corresponding graph in correspondence with an input equation. In addition, the function key 372 may be a function key for dividing and displaying the first and the second applications. In other words, different from the exemplary embodiment of FIG. 3B or 3C, the function key 372 may be supported by the application layer, not by the framework.

FIG. 3F illustrates a display of screen division in an apparatus according to an exemplary embodiment of the present invention.

Referring to FIG. 3F, when the user designates the function key 372, the controller 110 displays an execution screen 380 of the second application on the second window and an execution screen 371 of the first application on the first window. The function key 372 may also be readjusted in size and displayed on the execution screen 371 of the first application.

As described above, the apparatus 200 may support the screen division display function key in the framework or support the screen division display function key on an individual application layer.

FIG. 3G illustrates a display of a divided screen in an apparatus according to an exemplary embodiment of the present invention.

Referring to FIG. 3G, the touch screen 210 is divided by a separation 270 into a first application screen 240 and a second application screen 250. A lower portion bar 390 may be displayed at the lower portion of the touch screen 210 of the apparatus 200. The lower portion bar 390 may be displayed not to overlap with the execution screen of the first application A or the second application B. The lower portion bar 390 may be elongated in the horizontal direction at the lower portion of the touch screen 210 and may include standard function buttons 391 through 394.

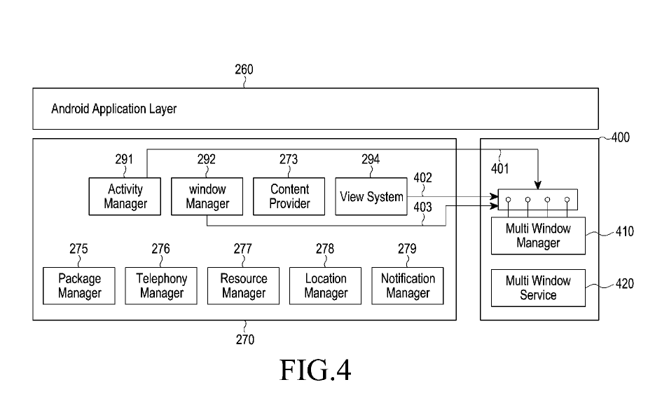

FIG. 4 illustrates a framework according to an exemplary embodiment of the present invention.

Referring to FIG. 4, in the framework 270, an activity manager 291, a window manager 292, and a view system 294 may be interchanged with a multi window framework 400, as indicated by 401, 403, and 402, respectively.

The multi window framework 400 includes a multi window manager 410 and a multi window service 420. The activity manager 291, the window manager 292, and the view system 294 may perform a function of calling an API for the multiple windows.

The multi window manager 410 performs a function of the multi window service 420 in a form of API to the user and a manager/service structure may operate based on an IPC. The multi window service 420 tracks an execution cycle of applications executed in the multiple windows and manages a state, such as a size and a location of each application.

The summoned API may manage a size, a location, and visibility of each application.

As described above, a framework may be performed in a method of providing an independent multi window framework to call the API.

Additionally, the application layer 260 may directly call the API from the multi window manager 410. In other words, when developing a new application, the user may be provided with the API provided from the multi window manager 410 and use the API.

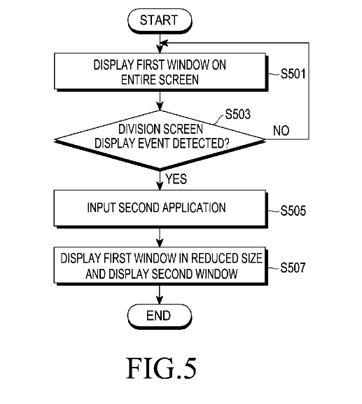

FIG. 5 is a flowchart illustrating a method of executing multiple applications according to an exemplary embodiment of the present invention.

Referring to FIG. 5, the controller 110 displays the first window for executing the first application on an entire screen of the touch screen 210 in step S501. Here, the entire screen of the touch screen 210 may indicate an area which excludes a lower portion bar.

The controller 110 may determine whether a preset event for a division screen display is detected in step S503. The preset event may be a designation of a division screen display function key.

When the preset event for the division screen display is not detected (‘No’ to S503), the first window in which the first application is executed is displayed on an entire screen of the touch screen 210. When the preset event for the division screen display is detected (‘Yes’ to S503), the controller 110 may display the application list including the second application and may receive a command for executing the second application from the user in step S505.

When the command for executing the second application is received, the first window is displayed in a reduced size and the second window in which the second application is executed may be displayed in step S507.

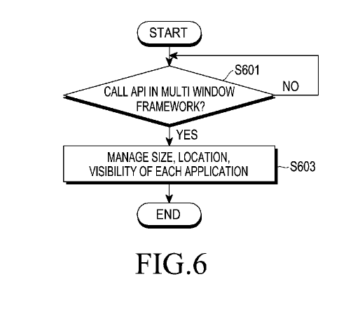

FIG. 6 is a flowchart illustrating a method of executing multiple applications according to an exemplary embodiment of the present invention.

Referring to FIG. 6, when the API of the multi window framework is called (‘Yes’ in S601), the called API executes the application and a size, a location, and a visibility of each executed application may be managed in step S603. Accordingly, the application may operate based on an original execution cycle thereof.

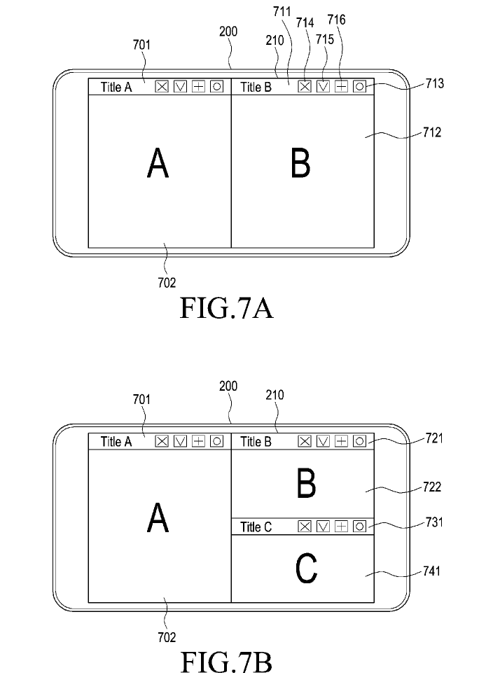

FIGS. 7A and 7B illustrate a display of screen division in an apparatus according to an exemplary embodiment of the present invention.

Referring to FIGS. 7A and 7B, the controller 110 displays a title bar 701 of the first application A and a title bar 711 of the second application B at an upper portion of the touch screen 210. Here, the title bar 701 of the first application A and the title bar 711 of the second application B are elongated in a horizontal direction to be adjacent to each other in the left and right direction. In one case, the controller 110 displays an execution screen 702 of the first application A and an execution screen 712 of the second application B. In another case, a screen division display function key 713 may be displayed on the title bar 711 of the second application B. On the other hand, a termination function key 714, a minimization function key 715, and a recovery function key 716 may also be displayed.

The user may designate the screen division display function key 713 and input a command for executing a third application C, and the controller 110 may divide an existing second window area into the second window and a third window accordingly.

The controller 110 divides the second window in the upward and downward direction in FIG. 7A and displays a title bar 721 of the second application B and an execution screen 722 of the second application B at an upper portion. In addition, the controller 110 displays a title bar 731 of the third application C and an execution screen 741 of the third application C at a lower portion. As described above, the controller 110 may not divide the screen not only by two applications but also by three or more applications, respectively, and display the divided the screen.

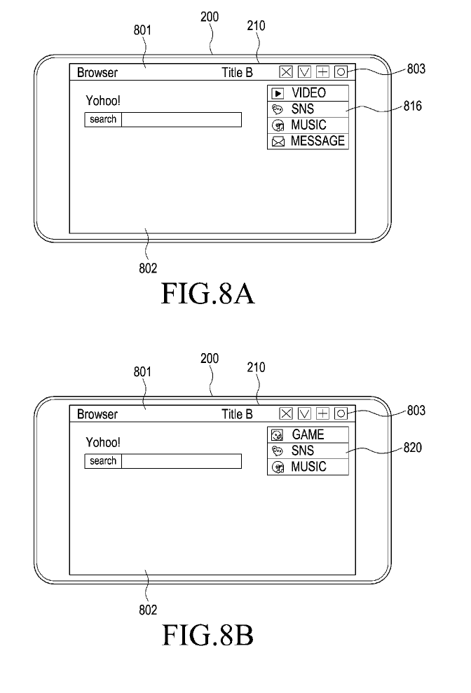

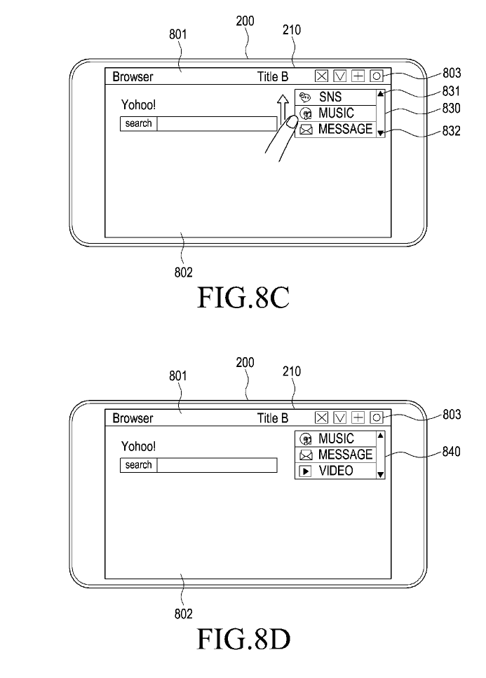

FIGS. 8A through 8D illustrate an application list according to an exemplary embodiment of the present invention.

Referring to FIGS. 8A through 8D, the controller 110 displays a title bar 801 at an upper portion of the touch screen 210 and displays an execution screen of the first application at a lower area 802 to the title bar 801. For example, the first application may be a web browser. On the other hand, when a designation of a screen division display function key 803 is input from the user, the controller 110 displays an application list 816 as covering the execution screen of the first application.

The application list 816 may include applications related to the first application currently being executed. For example, when the first application is the web browser, the application list 816 may include a video execution application, an SNS related application, a music multimedia execution application, and a text message application.

An SNS application is a service program for building a network online and is an application which may integrally manage not only a text message stored in the apparatus 200 but also an email and allow the user of the apparatus 200 to communicate with other person online or share and search for information. The SNS application may include Kakao Talk®, Twitter®, Facebook®, Myspace®, and Me2day®.

Applications, such as, for example, a text message application, an SNS application, a music application, a video application related to a specific application currently being executed, and the like, may be determined in advance as below.

According to search results of applications frequently used by the user of the apparatus 200 of various search agencies, it is found that applications, such as a web browser, a video, an SNS, an email, a message, a music, an Electronic-book (E-book), a game, a call, and the like, are most commonly used applications. The related application may be determined based on a search result of applications which are used together when executing a specific application.

Based on the search result, a combination of a currently executed application and a related application thereof may be determined as shown in Table 1.

TABLE 1

| Currently executed application | Related application |
|---|---|
| Web browser | Video |
| | SNS |
| | Music |
| | Message |
| Video | SNS |
| | E-mail |
| | Message |
| SNS | E-mail |
| | E-book |
| E-mail | Message |

Table 1 shows that an application which is the most used together with the web browser is the video application, the SNS application, the music application, and a message application. When executing the video application, an application most frequently used together may be the SNS application, an email application, or the message application.

The controller 110 may determine the application list based on a result as shown in Table 1.

Referring to FIG. 8B, an application list 820 may include recently executed applications. For example, it is assumed that the user executes a game application, the SNS application, and a music execution application prior to executing the first application currently executed.

The controller 110 may store information about a recently executed application and may display the application list 820 including the recently executed application. For example, the controller 110 may form the application list 820 according to a recently executed order. In other words, the controller 110 may display a most recently executed application, for example, the game application at a most upper portion of the application list 820. The SNS application executed prior to executing the game application may be displayed below the game application of the application list 820. Alternatively, the controller 110 may form the application list 820 based on user preference which is based on an execution frequency or an entire execution time of the executed application. For example, the controller 110 may display an application having a highest execution frequency or a highest entire execution time at the most upper portion of the application list 820 and may display next highest ranked applications below thereto. Namely, an application related to the first application may be an application having a high frequency of being used with the first application.

Referring to FIG. 8C, the controller 110 may display all of the stored applications in the application list 830. When the all of the stored applications are plural, the application list 830 may include an upward movement indicator 831 and a downward movement indicator 832. When the upward movement indicator 831 is designated, a display of the applications on the list may be moved upward to be displayed. When the downward movement indicator 832 is designated, the display of the applications on the list may be moved downward to be displayed. Alternatively, the user may input a gesture of touching a certain point on the application list 830 and flicking upward or downward. When an upward flick is input after a touch, the controller 110 may move the display of the applications on the list upward to be displayed.

Referring to FIG. 8D, it can be known that the music execution application and the message application displayed on second and third places of the application list 830 of FIG. 8C are displayed on first and second places of a changed application list 840. Moreover, it can be known that the video execution application is newly displayed on a third place of the application list 840 and a display of the SNS application which is displayed on a first place of the existing application list 830 is disappeared.

As described above, the application list may be formed in various ways and in conformity with user intuition, thereby maximizing convenience.

It should be noted that exemplary embodiments of the present invention may be implemented by hardware, software, or a combination of the hardware and the software. The software may be stored in a volatile or non-volatile storage device including a storage device, such as a ROM or a memory, such as a RAM, a memory chip, or an integrated circuit, and a storage medium, such as a Compact Disk (CD), a DVD, a magnetic disk, a magnetic tape, or the like, which enables an optical or magnetic recording as well as being readable by a machine (e.g., a computer). It should be understood that a method of renewing a graphic screen of the present invention may be implemented by a computer including a controller and a memory, and the memory is an example of a machine readable storage medium suitable for storing a program or programs including instructions that implement exemplary embodiments of the present invention. Therefore, exemplary embodiments of the present invention include a machine-readable storage medium which stores a program or programs including codes for implementing a method described by the appended claims.

The apparatus may receive and store the program from a program providing apparatus which is connected by a wire or wirelessly thereto. The program providing apparatus may include a memory for storing a program including instructions for performing a preset content protection method by a graphic processing apparatus and information needed for the content protection method, a communication unit for performing a wire or a wireless communication with the graphic processing apparatus, and a controller for transmitting a corresponding program to a transmission and receiving apparatus automatically or in response to a request from the graphic processing apparatus.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method of executing multiple applications in an apparatus including a touch screen, the method comprising:
displaying a first window in which a first application is executed on the touch screen;
detecting a division screen display event of the first application and a second application; and
decreasing a size of the first window on the touch screen when the division screen display event is detected and displaying, together with the first window, a second window in which the second application is executed on the touch screen.

2. The method of claim 1, wherein the displaying of the first window comprises:
displaying a title bar of the first application and an execution screen of the first application on an entire area of the touch screen.

3. The method of claim 2, wherein the title bar of the first application is displayed at an upper portion of the touch screen and the execution screen of the first application is displayed at an area lower to the title bar of the first application.

4. The method of claim 1, wherein the division screen display event is a designation of a division screen display function key for executing a division screen display.

5. The method of claim 4, wherein the division screen display function key is displayed on a title bar of the first application within the first window.

6. The method of claim 4, wherein the division screen display function key is displayed on an execution screen of the first application within the first window.

7. The method of claim 1, further comprising:
when the division screen display event is detected, displaying an application list including at least one application.

8. The method of claim 7, wherein the application list is displayed below the title bar of a first application within the first window and on an execution screen of the first application within the first window.

9. The method of claim 7, wherein the at least one application of the application list is an application having a relatively high frequency of being used with the first application.

10. The method of claim 7, wherein the at least one application of the application list is a recently executed application.

11. The method of claim 1, wherein the displaying, together with the first window, of the second window on the touch screen comprises:
displaying the first window without overlapping the second window.

12. The method of claim 11, wherein the first window and the second window divide the touch screen and are adjacent to each other in at least one of an upward direction, a downward direction, a left direction, and a right direction.

13. The method of claim 1, wherein the displaying, together with the first window, of the second window on the touch screen comprises:
displaying a lower portion bar including at least one standard function button for supporting a standard function of the apparatus below the first window and the second window.

14. An apparatus for executing a plurality of applications, the apparatus comprising:
a touch screen for displaying a first window in which a first application is executed; and
a controller for detecting a division screen display event of the first application and a second application and for decreasing a size of the first window on the touch screen when the division screen display event is detected and displaying, together with the first window, a second window in which the second application is executed on the touch screen.

15. The apparatus of claim 14, wherein the controller displays a title bar of the first application and an execution screen of the first application on an entire area of the touch screen.

16. The apparatus of claim 14, wherein the controller displays a title bar of the first application at an upper portion of the touch screen and displays an execution screen of the first application at an area lower to the title bar of the first application.

17. The apparatus of claim 14, wherein the division screen display event is a designation of a division screen display function key for executing a division screen display.

18. The apparatus of claim 17, wherein the division screen display function key is displayed on a title bar of the first application within the first window.

19. The apparatus of claim 17, wherein the division screen display function key is displayed on an execution screen of the first application within the first window.

20. The apparatus of claim 14, wherein, when the division screen display event is detected, the controller displays an application list including at least one application.

21. The apparatus of claim 20, wherein the controller displays the application list below a title bar of the first application within the first window and on an execution screen of the first application within the first window.

22. The apparatus of claim 20, wherein the at least one application of the application list is an application having a relatively high frequency of being used with the first application.

23. The apparatus of claim 20, wherein the at least one application of the application list is a recently executed application.

24. The apparatus of claim 14, wherein the controller displays the first window without overlapping the second window.

25. The apparatus of claim 24, wherein the controller controls such that the first window and the second window divide the touch screen and are adjacent to each other in at least one of an upward direction, a downward direction, a left direction, and a right direction.

26. The apparatus of claim 14, wherein the controller displays a lower portion bar including at least one standard function button for supporting a standard function of the apparatus below the first window and the second window.
